(19) United States
(12) Patent Application Publication
(10) Pub. No.: US 2014/0352272 A1
(43) Pub. Date: Dec. 4, 2014

(54) Sugarcane Harvester Attachment

(71) Applicant: Caterpillar Inc., Peoria, IL (US)

(72) Inventors: Jeffrey M. Parker, Fuquay Varina, NC (US); Justin D. Speichinger, Edwards, IL (US)

(21) Appl. No.: 13/906,832

(22) Filed: May 31, 2013

(51) Int. Cl. A01D 45/10

(52) U.S. Cl. CPC A01D 45/10
USPC 56/13.6; 56/94

(57) ABSTRACT

In one aspect, the disclosure provides a removable sugarcane harvester attachment including a coupler configured to couple the removable sugarcane harvester attachment to a machine. The removable sugarcane attachment includes at least one pair of counter-rotating row dividers; and at least one pair of counter-rotating base cutters located intermediate of the coupler and the at least one pair of counter-rotating row dividers.

### TECHNICAL FIELD

The present disclosure relates generally to sugarcane harvesters and, more particularly, to a removable sugarcane harvester attachment.

### BACKGROUND

Currently sugarcane that is grown on sloped terrain (e.g., hillsides) is harvested by hand after the sugarcane field has been burned to remove excess vegetation. Not only is manual harvesting a slow process, the burning of sugarcane fields may be, or already is, prohibited in various countries. Thus, in the future sugarcane may not be able to be manually harvested.

Traditional sugarcane harvester machines may be too big or bulky to be used on sloped terrain. Certain conventional harvester machines are monolithic in construction, which means the harvester part of the machine is fixed to a body of the machines and is not generally removable. As a result, when the harvest season is over, these machines remain idle reducing a return on investment for the sugarcane farmer.

Japanese Patent Publication 2000102314A (JP '314), entitled “Sugarcane Reaper Utilizing Tractor for Farming,” purports to address the problem of installation and removal of attachments to a tractor used for sugarcane reaping. The IP '314 publication describes a structure of a sugarcane harvester that requires a divider attachment installed on the front part of a vehicle body frame of a farming tractor and a base cutter attachment attached to a three point link at a rear side of the farming tractor. A discharger roller is positioned to a center of the rear side of the divider attachment. The design discussed in the JP '314 publication, however, may still not produce a clean cut, especially on sloped terrain, and requires multiple parts in the front and the back of the tractor. For example, the spatial distance between the divider attachment in the front and the base cutter attachment in the back may lead to disorientation of the sugarcane pulled or separated by the divider attachment. Accordingly, there is a need for a lightweight integrated one-piece removable or detachable sugarcane harvester attachment.

### SUMMARY

In one aspect, the disclosure provides a removable sugarcane harvester attachment including a coupler configured to couple the removable sugarcane harvester attachment to a machine. The removable sugarcane attachment includes at least one pair of counter-rotating row dividers; and at least one pair of counter-rotating base cutters located intermediate of the coupler and the at least one pair of counter-rotating row dividers.

In another aspect, the disclosure provides a method of a method of making a removable sugarcane harvester attachment. The method provides a coupler configured to couple the removable sugarcane harvester attachment to a machine. The method provides a pair of row dividers configured to divide two or more rows of sugarcane. The pair of row dividers are part of the removable sugarcane harvester attachment configured to removably couple to a machine. The method provides a pair of counter-rotating base-cutters located intermediate of the coupler and the pair of counter-rotating row dividers.

In yet another aspect, the disclosure provides a sugarcane harvester. The sugarcane harvester includes a machine and a removable sugarcane harvester attachment coupled to the machine. The removable sugarcane harvester attachment includes a coupler configured to couple the removable sugarcane harvester attachment to the machine. The removable sugarcane harvester attachment includes at least one pair of counter-rotating row dividers. The removable sugarcane harvester attachment includes at least one pair of counter-rotating base cutters located intermediate of the coupler and the at least one pair of counter-rotating row dividers.

### BRIEF DESCRIPTION OF THE DRAWINGS

FIG. 1 is a diagram representing an embodiment of a sugarcane harvester.

FIG. 2 illustrates a top view of the sugarcane harvester of FIG. 1.

FIG. 3 illustrates a backside view of the sugarcane harvester of FIG. 1.

FIG. 4 illustrates a front view of the sugarcane harvester of FIG. 1,

FIG. 5 illustrates a front view of a removable sugarcane harvester attachment of the sugarcane harvester of FIG. 1,

FIGS. 6A and 6B illustrate, respectively, two different back views of the removable sugarcane harvester attachment of the sugarcane harvester of FIG. 1.

FIG. 7 illustrates a bottom view of the removable sugarcane harvester attachment of the sugarcane harvester of FIG. 1.

FIGS. 8, 9, and 10 illustrate different views of a coupling system, for removable coupling of the removable sugarcane harvester attachment to a machine shown in FIG. 1,

FIG. 11 presents a flowchart for a process or a method for making a removable sugarcane harvester attachment.

### DETAILED DESCRIPTION

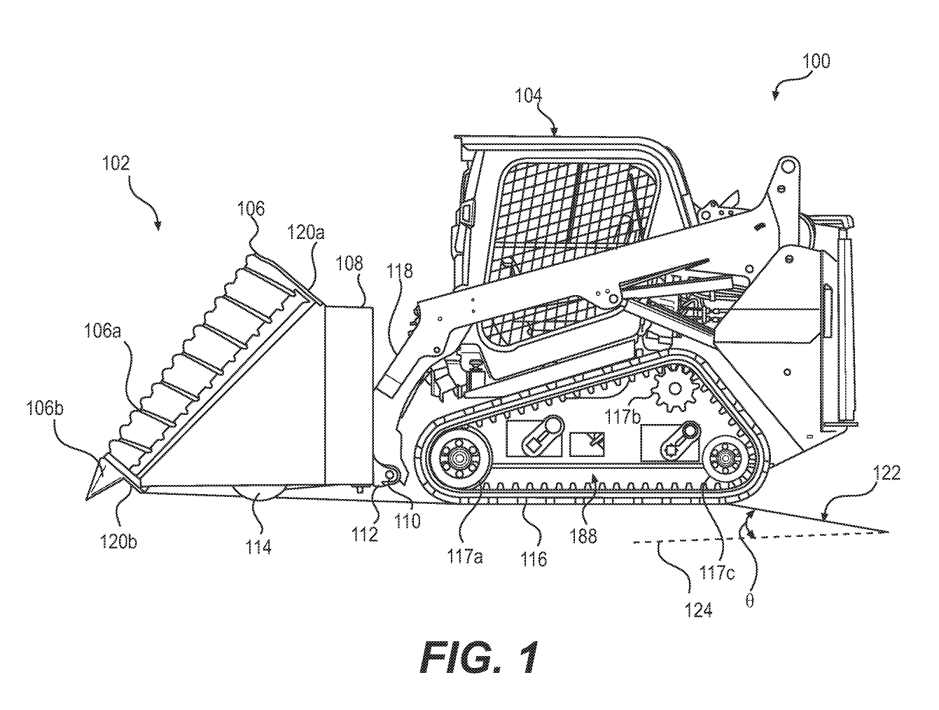

Now referring to the drawings, wherein like reference numbers refer to like elements, FIG. 1 illustrates an embodiment of a sugarcane harvester 100. In the example of FIG. 1, a side view or elevation view of the sugarcane harvester 100 is illustrated. The sugarcane harvester 100 includes a removable sugarcane harvester attachment 102 and a machine 104. The removable sugarcane harvester attachment 102 is removably coupled to the machine 104. In the view shown in FIG. 1, the sugarcane harvester 100 rests or moves on a ground 122. Sugarcane that is to be harvested using sugarcane harvester 100 grows on ground 122. The ground 122 has terrain that is at an angle θ with respect to a horizon 124. By way of example only, the angle θ can vary from 0° to 30°, although other values of 0 may exist. When the angle θ is greater than 0°, or less than 0°, the ground 122 is said to have a slope or sloped terrain. Such a slope or sloped terrain may be on a hill side, for example. The angle θ may vary over different portions of the ground 122. Alternatively or additionally, the sugarcane harvester 100 with the removable sugarcane harvester attachment 102 may be used on flat terrain (θ=0° or θ≈0°).

The removable sugarcane harvester attachment 102 and/or individual components thereof may be made of metal or alloys, or materials (e.g., elastomeric materials), or combinations thereof. In one embodiment, removable sugarcane harvester attachment 102 includes a body 108, a pair of row dividers, of which only a row divider 106 is illustrated in FIG. 1, a pair of guide wheels, of which only a guide wheel 114 is illustrated in FIG. 1, and one or more couplers, of which only a coupler 112 is illustrated in FIG. 1. The removable sugarcane harvester attachment 102 includes other components shown in FIGS. 1-10 and discussed herein.

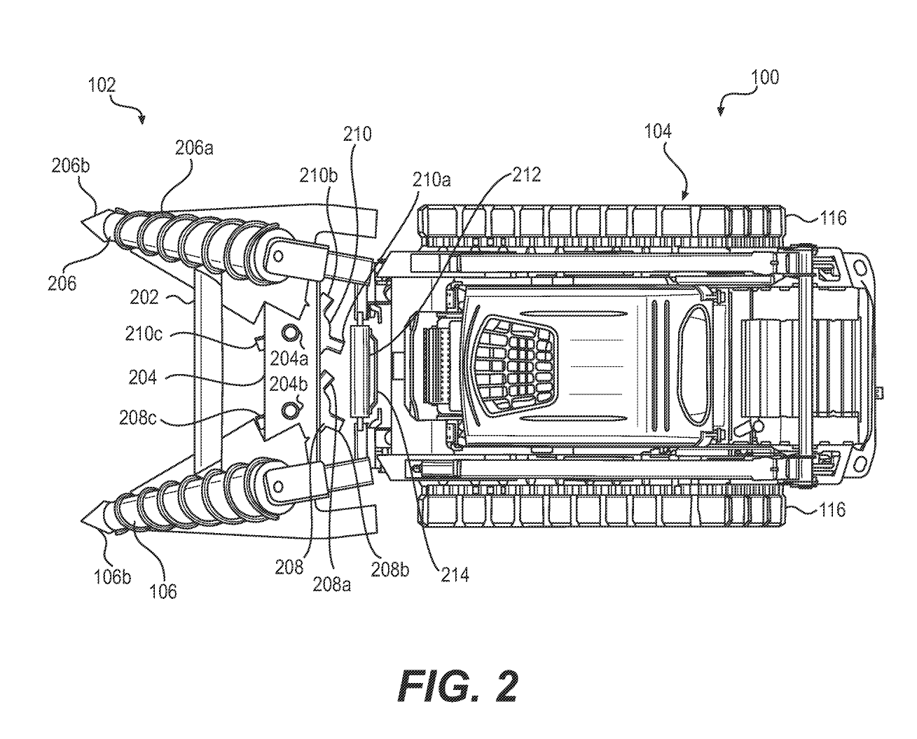

The body 108 has various surfaces, as also shown in FIGS. 2-10, to which various other components of the removable sugarcane harvester attachment 102 may be attached or welded. For example, the body 108 includes a pair of attachments 120a and 120b that attach the row divider 106 to the body 108. Likewise, the body 108 includes two parts (shown in FIG. 2, for example) that render the removable sugarcane harvester attachment 102 in a flared-out configuration from a rear end near the machine 104 to a front end near the attachment 120b. Such a flared-out arrangement is discussed in FIG. 2, for example. Although the side view of the removable sugarcane harvester attachment 102 shows the body 108 to be in a trapezoidal shape, other shapes of the body 108 may be used.

The row divider 106 includes a spiral arrangement 106a and a pointed conical tip 106b, among other parts discussed with respect to FIGS. 2-10. The spiral arrangement 106a is shaped to keep sugarcane that is being harvested to be contained within the body 108, as well as to split the rows of vegetation (including sugarcane) such that they are in a proper orientation for harvesting. The pointed conical tip 106b aids in orienting the sugarcane knocked down during operation of the sugarcane harvester 100 in a manner that makes a bottom part or butt of the sugarcane more accessible for smooth cutting. It is to be noted that other shapes may be used. The operation of the spiral arrangement 106a and the pointed conical tip 106b of the row divider 106 is known, and will not be described in detail.

The guide wheel 114 is configured to aid motion of the removable sugarcane harvester attachment 102. In one embodiment, the guide wheel 114 is aligned with a tip of a blade (not shown in FIG. 1), as discussed with respect to FIGS. 2-10. The guide wheel 114 is coupled to actuators (not shown) inside the body 108 to adjust a height of the removable sugarcane harvester attachment 102, in use. Such actuators may be hydraulic cylinders, or other types of mechanical/electro-mechanical actuators. The guide wheel 114 is one of a pair of guide wheels as discussed with respect to other views shown in FIGS. 2-40.

The machine 104 illustrated in FIG. 1 may be one of a tractor, a skid steer loader (SSL), a multi-terrain loader (NTL), a compact track loader (CTL), or a compact wheel loader (CWL), although other types of known movable machines may be used. The machine 104 may be movable by an engine-based driving system. The machine 104 moves on the ground 122 by way of tracks 116. When the machine 104 moves, tracks 116 are set in motion by one or more wheels 117a, 117b, and 117c coupled to a power train of the machine 104 (not shown). Movement and control/operation of the machine 104 is known and will not be described herein.

During motion of the machine 104 with the removable sugarcane harvester attachment 102, tracks 116 change shape according to terrain of the ground 122. For example, in a typical sugarcane harvesting scenario, the ground 122 may not be uniformly flat and the tracks 116 may take the shape of the instantaneous terrain of the ground 122 on which the machine 104 is moving. The machine 104 includes a lift arm 118. The lift arm 118 supports the removable sugarcane harvester attachment 102. For example, the lift arm 118 may include multiple points of attachment (as discussed with respect to FIGS. 2-10), of which a hinge pin 110 coupled to the coupler 112 is illustrated in FIG. 1.

FIG. 2 illustrates a top view of the sugarcane harvester 100 including the removable sugarcane harvester attachment 102 and the machine 104. In the view shown in FIG. 2, additional components of the sugarcane harvester 100, and relative arrangements thereof, are shown. Similar to the row divider 106, the removable sugarcane harvester attachment 102 includes a row divider 206. The row dividers 106, 206 form a pair of row dividers. In one embodiment, in the flared-out arrangement of the removable sugarcane harvester attachment 102, the pair of row dividers 106, 206 are in a non-parallel arrangement such that a distance between a pointed conical tip 206b of the row divider 206 and the pointed conical tip 106b is greater than a distance between the respective top parts of the row dividers 106 and 206. Such a flared-out arrangement of the removable sugarcane harvester attachment 102 with the row dividers 106, 206 in a non-parallel arrangement allows more sugarcane to be gathered in between the row dividers 106, 206 and into the removable sugarcane harvester attachment 102 as compared to a parallel arrangement, for example. Like row divider 106, row divider 206 includes a spiral arrangement 206a in a direction counter to a direction of the spiral arrangement 106a shown in FIG. 1. In use, row divider 106 and row divider 206 are counter-rotating with respect to each other. In one embodiment, the removable sugarcane harvester attachment 102 may include more than one pair of row dividers 106, 206.

The removable sugarcane harvester attachment 102 includes a knock-down roller 202, a beam 204, a pair of base cutters 208 and 210, a spring loaded cylinder member 212, and a butt-lift roller 214. The knock-down roller 202 is positioned between the pair of row dividers 106, 206 and in front of the pair of base cutters 208, 210, the front being the part of the body 108 that is closest to the pointed conical tips 106b and 206b. The knock-down roller 202 is configured to bend or bow down sugarcane pulled in between the pair of counter-rotating row dividers 106 such that the butt of the sugarcane faces, and is easily accessible to, the pair of base cutters 208, 210 below the beam 204.

The beam 204 is positioned between the knock-down roller 202 and the spring loaded cylinder member 212 and/or the butt-lift roller 214. The beam 204 joins two parts of the body 108, each part attached respectively to the row divider 106 and the row divider 206, as illustrated in FIG. 2. The beam 204 couples to the pair of base cutters 208 and 210 via shaft endings 204b and 204a, respectively. The beam 204 may internally have motors (not shown) that drive the pair of base cutters 208, 210 via respective shafts to which the shaft endings 204b and 204a belong, respectively.

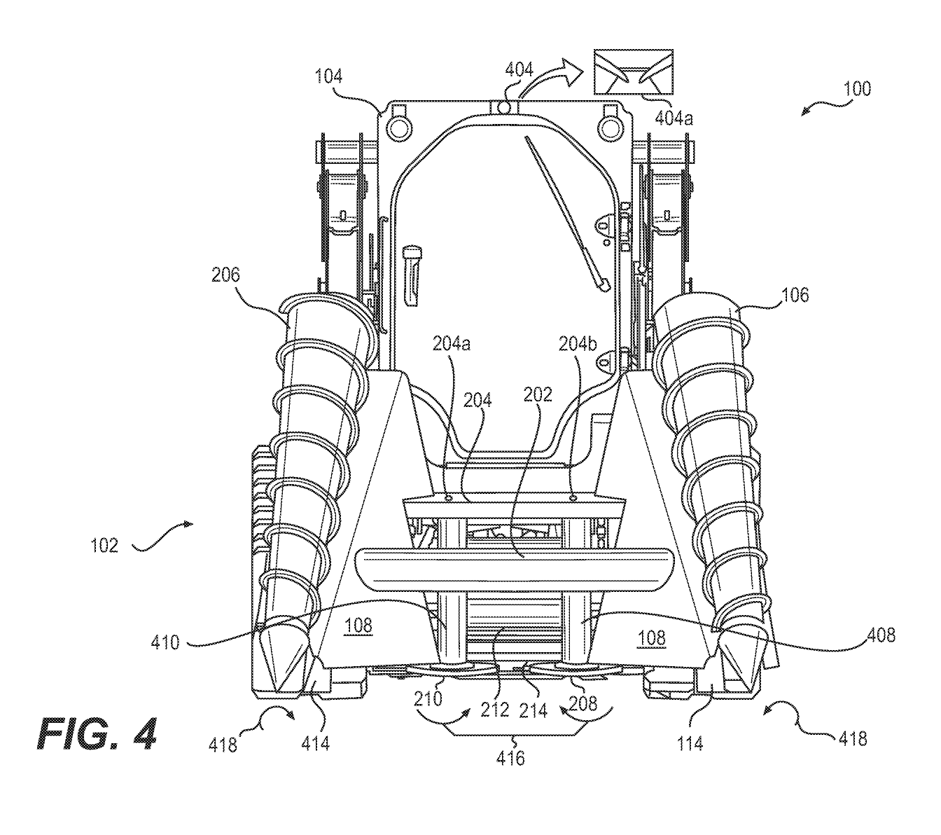

The pair of base-cutters 208 and 210 is configured to counter-rotate with respect to each other, as discussed with respect to FIGS. 4-10 below. Such counter-rotation is in opposing angular directions so as to aid pulling in of the knocked-down sugarcane towards the spring loaded cylinder member 212, as opposed to a direction that may cause the knocked-down sugarcane to be pushed away from the spring loaded cylinder member 212. The base cutter 208 includes removable sets of blades 208a, 208b, 208c, etc. Likewise, the base cutter 210 includes removable sets of blades 210a, 210b, 210c, etc. In use, the blades 208a, 208b, 208c, etc., and the blades 210a, 210b, 210c, etc., incur blunting or wear and tear. When the blades 208a, 208b, 208c, etc., and the blades 210a, 210b, 210c, etc., lose their sharpness, one or more of such blades may be replaced with new ones. In one embodiment, the removable sugarcane harvester attachment 102 may include more than one pair of base cutters 208, 210.

The spring loaded cylinder member 212 is arranged above the butt-lift roller 214, below and behind the beam 204, and behind the pair of counter-rotating base cutters 208, 210 (the term “behind” referring to a direction pointing towards the rear end of the removable sugarcane harvester attachment 102 near the machine 104). It is to be noted that the term “spring loaded” does not only refer to a physical spring attachment for the spring loaded cylinder member 212. Instead, “spring loaded” may refer to any flexible/elastic system or mechanism that allows force adaptive positioning or orientation of the spring loaded cylinder member 212. For example, the spring loaded cylinder member 212 may be a rubber roller having inherent elasticity or flexibility. The spring loaded cylinder member 212 is configured to receive the cut sugarcane from the pair of counter-rotating base cutters 208, 210 and push the cut sugarcane down towards the ground 122 and the butt-lift roller 214. In one embodiment, the spring loaded cylinder member 212 provides a downward pressure onto the sugarcane stock received from the knock-down roller 202 such that the butt-lift roller 214 can easily guide the cut sugarcane to a region 188 below the machine 104.

The butt-lift roller 214 is positioned between the rear end of the removable sugarcane harvester attachment 102 (near the machine 104) and the pair of counter-rotating base cutters 208, 210, and below the spring loaded cylinder member 212. The butt-lift roller 214 is configured to receive cut sugarcane from the pair of counter-rotating base cutters 208, 210 and to push the cut sugarcane towards the region 188 below the machine 104. Once the cut sugarcane is in the region 188 below the machine 104, the sugarcane harvester 100 can move forward over the cut sugarcane in the region 188 without stopping the operation of cutting additional sugarcane between the row dividers 106 and 206.

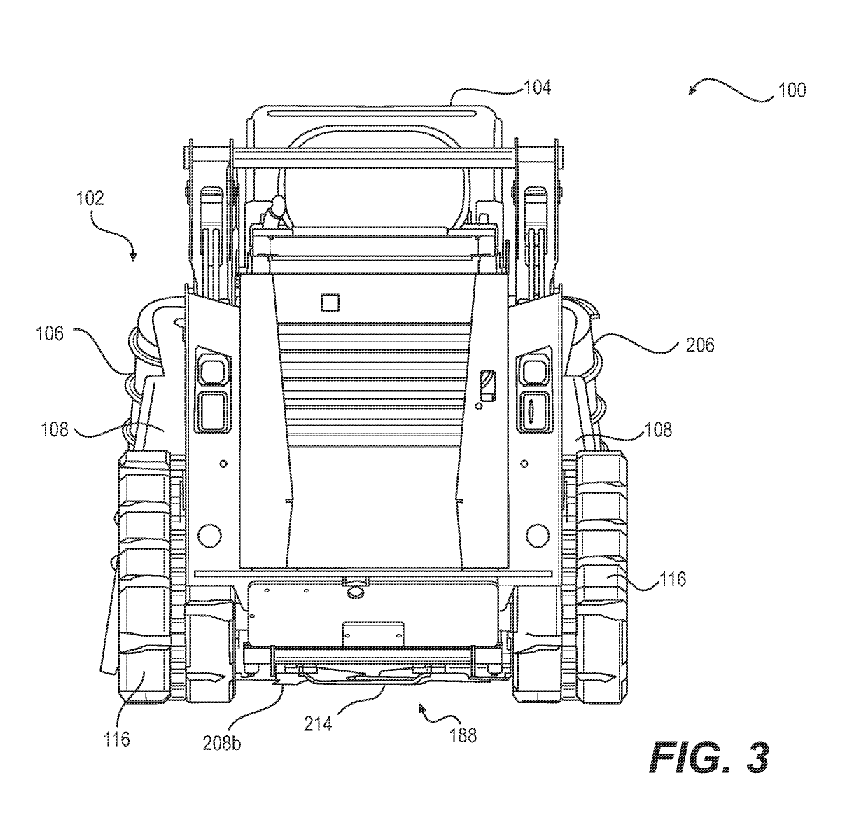

FIG. 3 illustrates the sugarcane harvester 100 from a backside of the machine 104. Some parts of the sugarcane harvester 100 discussed with respect to FIGS. 1 and 2 are shown in a different view in FIG. 3.

FIG. 4 illustrates a front view of the sugarcane harvester 100. In this front view, the knock-down roller 202 is shown extending between two parts of the body 108 of the removable sugarcane harvester attachment 102. As shown, the knock-down roller 202 is in front of shafts 408 and 410 of the base cutters 208 and 210, respectively. The shafts 408 and 410 are coupled to the beam 204 at the shaft endings 204b and 204a, respectively. As indicated by counter-directional arrows 416, the base cutters 208 and 210 (and shafts 408, 410) counter-rotate with respect to each other to cut the sugarcane (not shown) knocked down by the knock-down roller 202. Likewise, as indicated by counter-directional arrows 418, the row dividers 106 and 206 are counter-rotating with respect to each other to initially divide the rows of sugarcane (not shown). In addition, the relative orientation of the spring loaded cylinder member 212 and the butt-lift roller 214 is shown in FIG. 4, where the spring loaded cylinder member 212 is in front of the butt-lift roller 214 in the front view illustrated in FIG. 4.

FIG. 4 illustrates a second guide wheel 414 similar to the guide wheel 114. The guide wheel 414 is configured to aid in motion of the removable sugarcane harvester attachment 102. In one embodiment, the guide wheel 414 is aligned with tips of blades 210a, 210b, 210c, etc. of the base cutter 210 and the guide wheel 114 is aligned with tips of blades 208a, 208b, 208c, etc. Like the guide wheel 114, the guide wheel 414 is coupled to actuators (not shown) inside the body 108 to adjust a height of the removable sugarcane harvester attachment 102, in use, for example, based upon terrain of the ground 122 on which the machine 104 moves to harvest sugarcane. Such actuators may be hydraulic cylinders, manual screw type movers or other types of mechanical/electro-mechanical actuators to move the guide wheels 114, 414 up or down.

FIG. 4 illustrates an imaging device 404 positioned on a top part of the machine 104, although the imaging device 404 may be positioned at other places on the machine 104 and/or the removable sugarcane harvester attachment 102. In one embodiment, the imaging device 404 may be a camera. An image 404a of the removable sugarcane harvester attachment 102 may be viewed using the imaging device 404 by an operator of the machine 104. Based upon the image 404a from the imaging device 404 displayed on a display (not shown) inside the machine 104, or elsewhere (e.g., in a remote operator station/room), an operator of the sugarcane harvester 100 can adjust the orientation, height, speed, or other spatial or temporal parameters of the removable sugarcane harvester attachment 102 and/or the machine 104. In one embodiment, more than one imaging device may be used. In one embodiment, the imaging device 404 is optional or is independent of the sugarcane harvester 100.

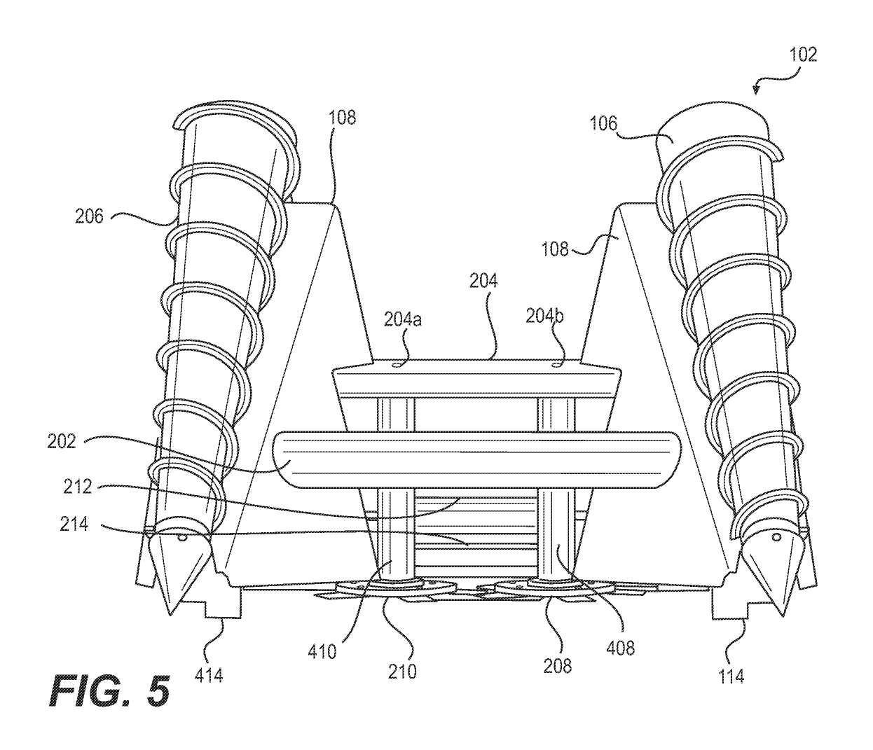

FIG. 5 illustrates a standalone front view of the removable sugarcane harvester attachment 102. For example, the term “standalone” relates to the removable sugarcane harvester attachment when removed or separated or detached from the machine 104. In FIG. 5, the removable sugarcane harvester attachment 102 is shown enlarged to more clearly show the relative arrangement of the knock-down roller 202, the beam 204, the shafts 408 and 410 of the counter-rotating base cutters 208 and 210, respectively, along with the spring loaded cylinder member 212 and the butt-lift roller 214.

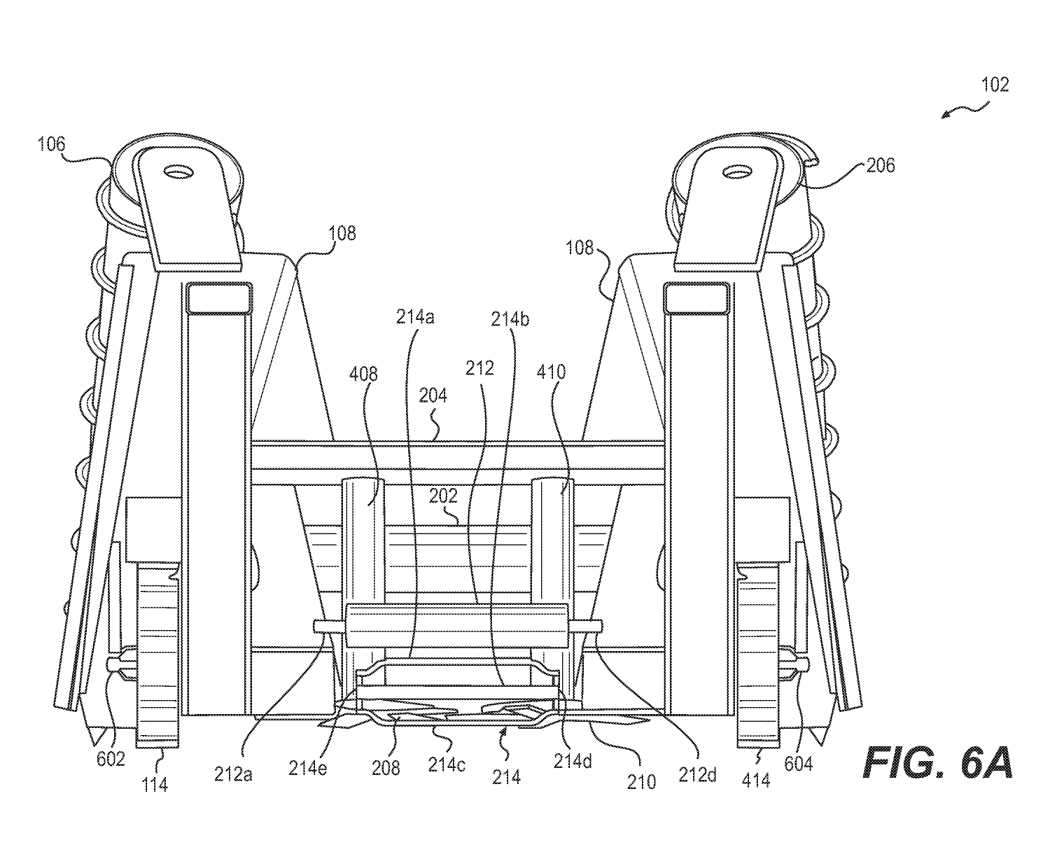

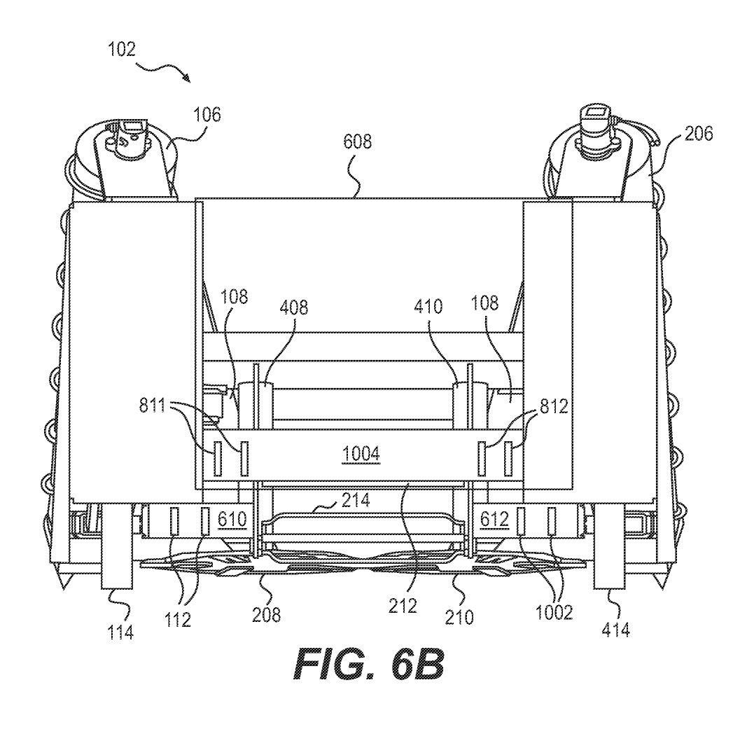

FIG. 6A illustrates a standalone back view of the removable sugarcane harvester attachment 102, for example, when removed or separated or detached from the machine 104. In FIG. 6, the removable sugarcane harvester attachment 102 is shown enlarged to more clearly show the relative arrangement of the knock-down roller 202, the beam 204, the shafts 408 and 410 of the counter-rotating base cutters 208 and 210, respectively, along with the spring loaded cylinder member 212 and the butt-lift roller 214. In the back view of the removable sugarcane harvester attachment 102 shown in FIG. 6A, the butt-lift roller 214 includes a plurality of spatially separated crosspieces or spokes 214a, 214b, and 214c, although more or lesser number of spokes may be present. The spokes 214a, 214b, and 214c are conjoined at two ends 214e and 214f of the butt lift roller 214. In use, the spokes 214a, 214b, and 214c are configured to pull the cut sugarcane from the spring loaded cylinder member 212 and push out the cut sugarcane to underneath the machine 104 for subsequent pickup. It is to be noted that although only three spokes 214a, 214b, and 214c are illustrated in FIG. 6A, more or less number of spokes may be used. As also illustrated, the spring loaded cylinder member 212 is attached to the body 108 via extensions 212a and 212d. FIG. 6A further illustrates a pair of attachment rollers 602 and 604 to which guide wheels 114 and 414, respectively, may be attached,

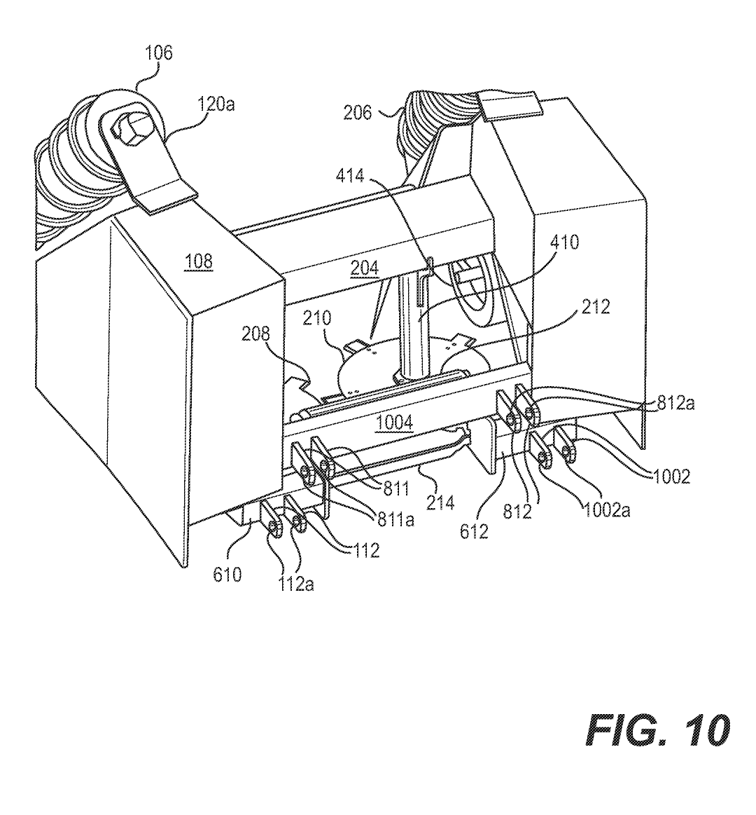

FIG. 6B illustrates another standalone back view of the removable sugarcane harvester attachment 102, thr example, when removed or separated or detached from the machine 104. FIG. 6B shows a frame 608 that is attached to the backsides of the two flared-out parts of the body 108. The frame 608 is attached to confine the pulled-in or cut sugarcane within the two flared-out parts of the body 108. The frame 608 provides holes/slits through which a pair of couplers 811 and 812 on an additional beam 1004 (discussed with respect to FIG. 10) pass through, respectively. As discussed below, the pair of couplers 811 and 812 form a part of a coupling system that makes the removable sugarcane harvester attachment 102 easily removable from the machine 104. Likewise, beams 610 and 612 may include corresponding holes (not shown) for the coupler 112 and a coupler 1002 (also discussed with respect to FIG. 10). The coupler 112 and 1002 further hold the removable sugarcane harvester attachment 102 to the lift arm 118 of the machine 104. The view shown in FIG. 6B shows the spring loaded cylinder member 212 (e.g., a rubber roller) attached to the body 108 on respective frames thereof.

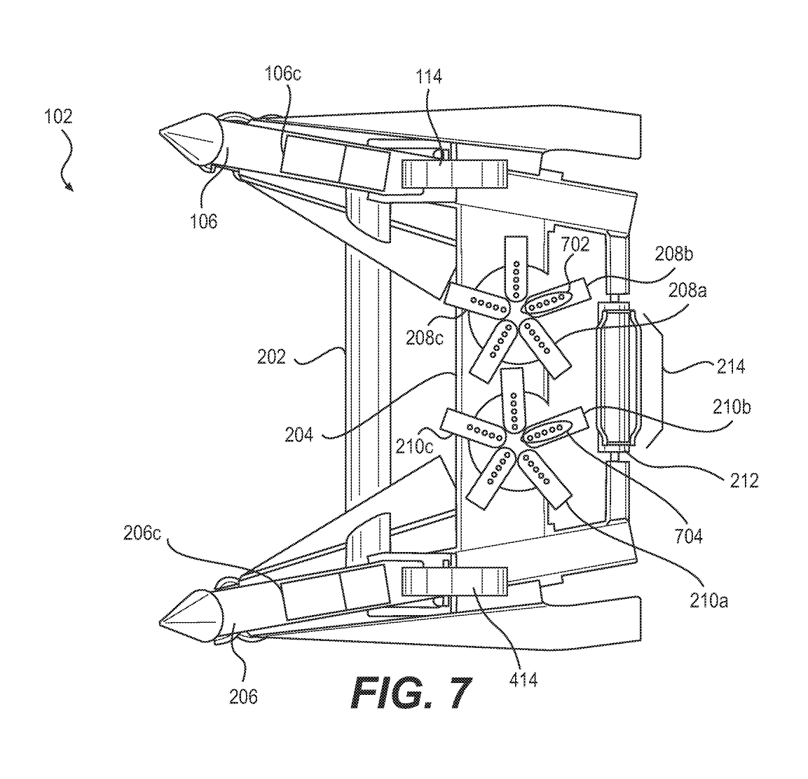

FIG. 7 illustrates a standalone bottom view of the removable sugarcane harvester attachment 102. In this view, a plurality of holes 702 on the blades 210a-210c of the base cutter 210 and a plurality of holes 704 on the blades 208a-208c of the base-cutter 208 are shown. The plurality of holes 702 and 704 allow screws (not shown) to be inserted to hold the blades 208a, 208b, 208c, and 210a, 210b, 210c, etc. When one or more of the blades 208a, 208b, 208c, and 210a, 210b, 210c, etc. wear out or lose sharpness, they are removed by unscrewing the screws and attaching new blades. Alternatively, or additionally, the plurality of holes 702, 704 allow the blades 208a, 208b, 208c, and 210a, 210b, 210c, etc. to be moved outwards to expose respective new surfaces for cutting as the blades 208a, 208b, 208c, and 210a, 210b, 210c, etc, loose sharpness or are worn down, in use. For example, the blades 208a, 208b, 208c, and 210a, 210b, 210c, etc. may be moved from the outermost of holes 702, 704 towards the innermost (towards a central part of the beam 204). FIG. 7 further illustrates attachments 106c and 206c. The attachments 106c and 206c may be internally connected to the guide wheels 114 and 414, respectively.

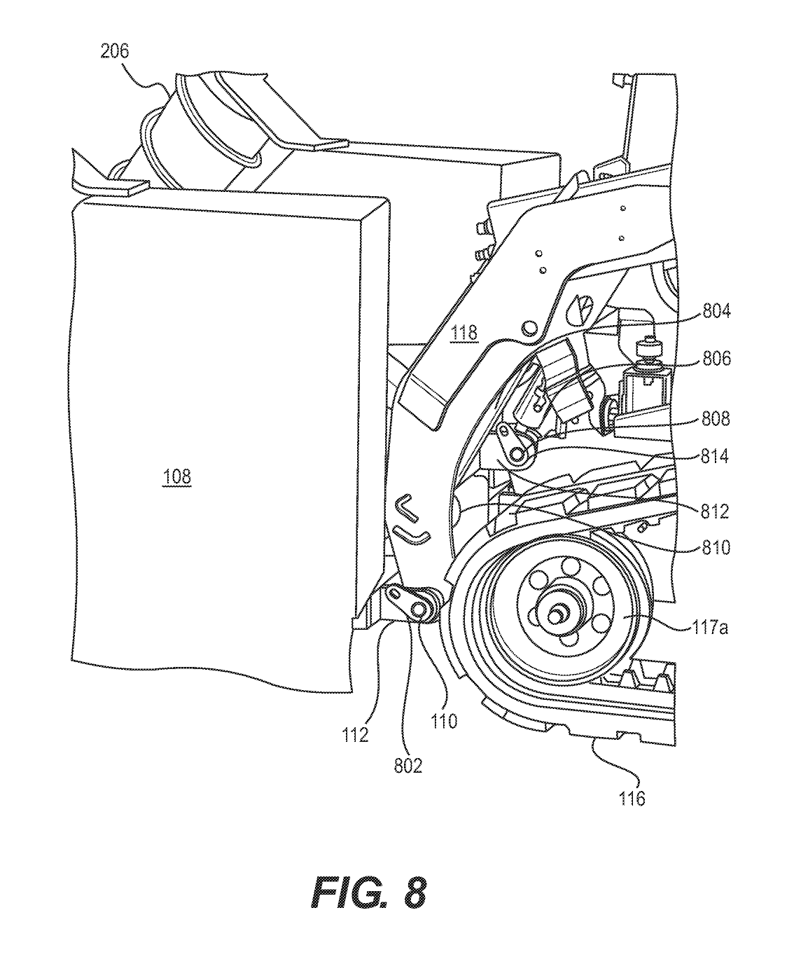

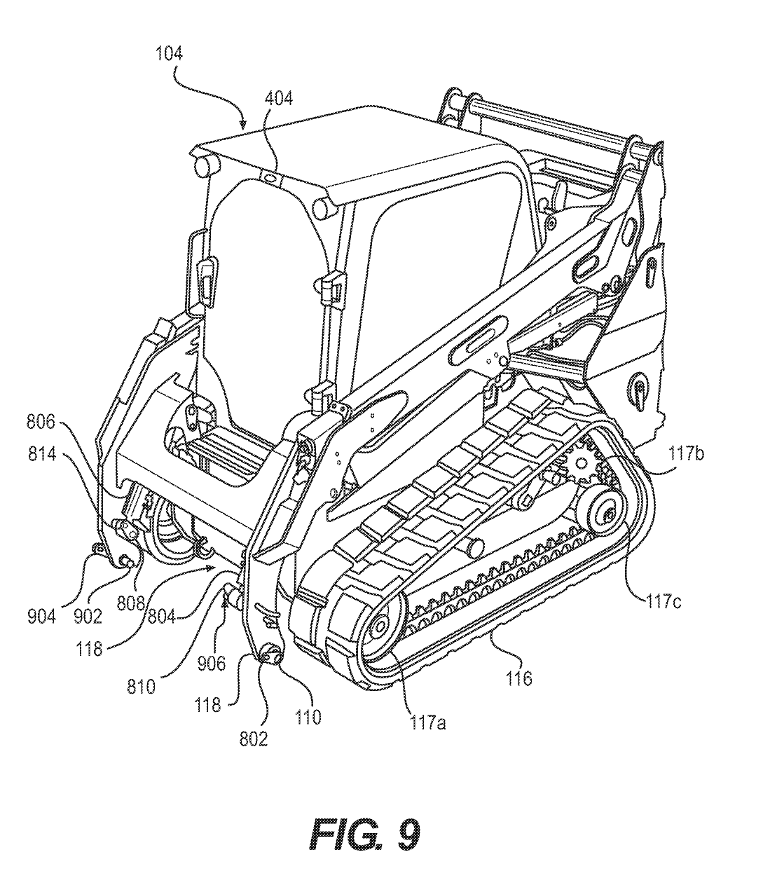

FIGS. 8, 9, and 10 illustrate different views of the coupling system, or of parts thereof for removable coupling of the removable sugarcane harvester attachment 102 to the machine 104. In the view shown in FIG. 8, a plate 802 is shown to hold the hinge pin 110 on the lift arm 118 of the machine 104 to the coupler 112 on the removable sugarcane harvester attachment 102. As illustrated in FIG. 10, by way of example only, the coupler 112 is or includes a bore that has two parts with holes 112a on each part through which the hinge pin 110 passes. Likewise, as shown in FIGS. 9-10, a plate 904 holds a hinge pin 902 on the lift arm 118 of the machine 104 to the coupler 1002 on the removable sugarcane harvester attachment 102. Likewise, the coupler 1002 may be or includes another bore similar to the coupler 112. Similar to the coupler 112, the coupler 1002 has two parts with holes 1002a on each part through which the hinge pin 902 passes. As part of the coupling system, FIGS. 8 and 9 illustrate a plate 810 to hold a hinge pin 906 to a coupler 811 (e.g., a bore). As illustrated in FIG. 10, the coupler 811 has two parts with holes 811a on each part through which the hinge pin 906 passes. Likewise, a plate 814 holds a hinge pin 808 to a coupler 812 of the removable sugarcane harvester attachment 102. It is to be noted that although couplers 112, 1002, 811, and 812 may exemplarily be bores, or may include bores, other forms of coupling systems such as spring loaded bearings, clamps, hydraulic couplers, etc., may be used. The couplers 112 and 1002 may be referred to herein as a first pair of couplers and the couplers 811 and 812 may be referred to herein as a second pair of couplers. It is to be noted that although only two hinge pins 110 and 902 and the two hinge pins 808 and 906 are illustrated in FIGS. 8-10, additional hinge pins may be used to couple the removable sugarcane harvester attachment 102 to the machine 104. The hinge pins 110 and 902 may be referred to as a first pair of hinge pins. Likewise, the hinge pins 808 and 906 may be referred to as a second pair of hinge pins.

FIGS. 8 and 9 illustrate a pair of actuators 804 and 806 coupled to hinge pins 906 and 808, respectively. As noted, such actuators may be hydraulic cylinders, screwable or clampable attachments, or other types of mechanical/electro-mechanical actuators. The actuators 804 and 806 are actuated by the machine 104 to rotate the hinge pins 906 and 808, respectively. In turn, the removable sugarcane harvester attachment 102 is rotated up or down to adjust an orientation thereof. For example, using the pair of hinge pins 906 and 808 coupled to the corresponding actuators 804 and 806, respectively, an orientation of the removable sugarcane harvester attachment 102 relative to a slope of terrain of the ground 122 (on which the harvesting is carried out) may be adjusted. Such adjustment may be carried out prior to or during harvesting. Construction and installation of actuators 804 and 806 is known, and will not be described herein.

FIG. 9 illustrates a view of the machine 104 with the removable sugarcane harvester attachment 102 removed. The view shown in FIG. 9 makes the actuators 804 and 806 more clearly visible, along with a relative orientation of the actuators 804 and 806 with respect to the hinge pins 906 and 808. A rotation of the lift arm 118 up results from a contraction in a length of the actuators 804 and 806. Likewise, a rotation of the lift arm 118 down results from an expansion in the length of the actuators 804 and 806. Such up or down rotation is transmitted via the coupling system to the removable sugarcane harvester attachment 102. It is to be noted that additional number of actuators similar to the pair of actuators 804, 806 may be used.

FIG. 10 illustrates another backside view of the removable sugarcane harvester attachment 102, removed from the machine 104. The removable sugarcane harvester attachment 102 includes the additional beam 1004 that acts as a base to which the second pair of couplers 811 and 812 may be attached or welded. The additional beam 1004 may include additional couplers (e.g., bores). The additional beam 1004 is located above and behind the spring loaded cylinder member 212 and the butt-lift roller 214, as illustrated. Further, FIG. 10 illustrates the beams 610 and 612 for attaching the couplers 112 and 1002, respectively, to the machine 104.

### INDUSTRIAL APPLICABILITY

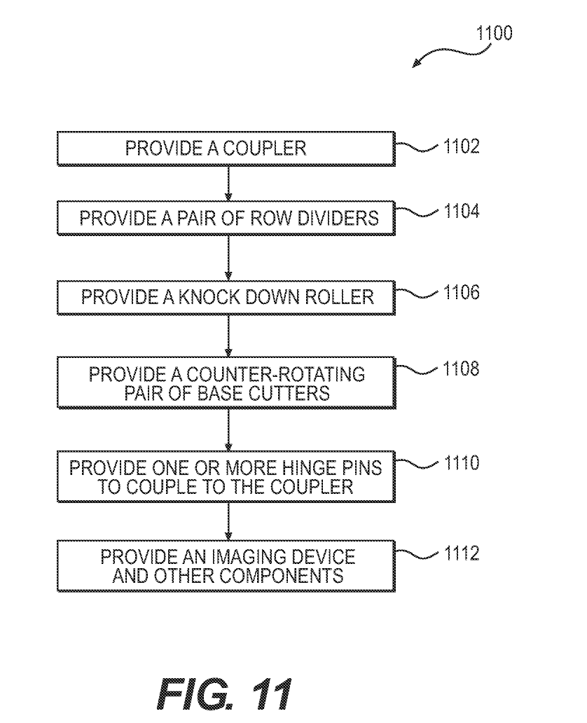

The present disclosure is applicable generally to sugarcane harvesters and, more particularly, to the removable sugarcane harvester attachment 102. FIG. 11 presents a flowchart for a process or a method 1100 of making the removable sugarcane harvester attachment 102. Conventionally, current sugarcane harvester attachments are bulky and complex in their design. Such sugarcane harvester attachments are generally not removable from the machines that move them. In other words, such machines have the sugarcane harvester attachment as an integral part of the machine. Further, due to their size, such sugarcane harvesters are not suitable for operation on hill slopes or other non-flat terrain. Various aspects of the disclosure provide the removable sugarcane harvester attachment 102 that is compact and is removable from the machine 104 that carries it. The compact design and features (shown, for example, in FIGS. 1-10) allow the removable sugarcane harvester attachment 102 to be easily used on hill slopes or other non-flat terrain, and attach to the front part of the machine 104.

In one aspect, one or more processes in the method 1100 may be carried out in an assembly line deploying various tools, robotic arms, etc. to make the removable sugarcane harvester attachment 102. A machine making or arranging the removable sugarcane harvester attachment 102 may be controlled by a processor and/or an operator (not shown), for example. Alternatively, one or more processes in the method 1100 may be carried out manually. One or more processes in the method 1100 may be carried out using a combination of manual and machine/computer-based actions. Further, in one aspect, processes in the method 1100 may be transferable between manual and machine/computer-based actions. Furthermore, one or more processes may be skipped or combined as a single process, repeated several times, and the flow of processes in the method 1100 may be in any order not limited by the specific order illustrated in FIG. 11. For example, one or more processes may be moved around in terms of their respective orders, or may be carried out in parallel with one or more other processes.

The method 1100 may begin in an operation 1102 where a coupler configured to couple the removable sugarcane harvester attachment 102 to machine 104 is provided. Such a coupler may be one or more of the coupler 112, the coupler 1002, and/or the pair of couplers 811 and 812 provided on the body 108 of the removable sugarcane harvester attachment 102. The coupler may be provided by attaching, fusing or welding to the body 108. The couplers provide the coupling system for coupling the removable sugarcane harvester attachment 102 to the machine 104, e.g., to the lift arm 118 of the machine 104.

In an operation 1104, the pair of row dividers 106, 206 configured to divide two or more rows of sugarcane is provided. For example, the pair of row dividers 106, 206 may be attached to the body 108 at the pair of attachments 120a and 120b, respectively. The pair of row dividers 106, 206 may be provided by attaching, fusing or welding to the pair of attachments 120a and 120b of the body 108. As discussed, the pair of row dividers 106, 206 may rotate in a counter-clockwise manner during operation of the sugarcane harvester 100.

In an operation 1106, the knock-down roller 202 is provided. The knock-down roller 202 may be provided between the pair of row dividers 106, 206 and the coupler. The knock-down roller 202 may extend between two flared-out portions of the body 108 (e.g., as illustrated in FIG. 2). The knock-down roller 202 may be provided by attaching, fusing or welding to the body 108. As discussed, the knock-down roller 202 is arranged to bend and knock-down the sugarcane between the pair of row dividers 106, 206.

In an operation 1108, the pair of counter-rotating base-cutters 208, 210 is provided. The pair of counter-rotating base-cutters 208, 210 is located intermediate of the coupler and the at least one pair of counter-rotating row dividers 106, 206. The pair of counter-rotating base-cutters 208, 210 is configured to pull-in and cut the knocked-down sugarcane. In one embodiment, the cutting of the sugarcane by the pair of counter-rotating base-cutters 208, 210 may be carried out an optimal height of 50-70 mm above a surface of the ground 122 upon which the sugarcane grows.

In an operation 1110, one or more hinge pins may be provided. Such hinge-pins may be one or more of the hinge-pins 110, 808, 902, and/or 906. In one embodiment, one or more of such hinge pins may be actuatable using actuators 804, 806 on the machine 104. Providing such hinge-pins may include inserting them in one or more holes 811a, 812a, 112a, and/or 1002a, as illustrated, for example, in FIG. 10. One or more of the hinge-pins may be actuated to adjust an orientation of the removable sugarcane harvester attachment 102 relative to a slope of terrain of the ground 122 on which sugarcane is harvested.

In an operation 1112, the imaging device 404 may be provided. It is to be noted that although the imaging device 404 is shown on the machine 104, the imaging device 404 may be provided elsewhere, for example, on the removable sugarcane harvester attachment 102. In addition, the operation 1112 may include providing the guide wheels 114, 414, and/or other parts of the removable sugarcane harvester attachment discussed with respect to FIGS. 1-10. For example, such parts may be welded, fused or otherwise attached to the body 108.

In a typical use case scenario, the removable sugarcane harvester attachment 102 may be attached to the machine 104, or any other movable machine. The machine 104 may be started by an operator of the machine 104. Upon starting, the machine 104 may move forward (or, backward) to move the attached removable sugarcane harvester attachment 102. For example, the machine 104 and the removable sugarcane harvester attachment 102 may be positioned such that a row of sugarcane is placed between the pair of counter-rotating row dividers 106 and 206. Additional rows of sugarcane may be present on either side of the body 108 of the sugarcane harvester 100.

Using the guide wheels 114 and 414, a height of the removable sugarcane harvester attachment 102 may be adjusted. An angular or rotational orientation of the removable sugarcane harvester attachment 102 may be adjusted using the pair of couplers 811 and 812 and associated hinge pins 906 and 808, respectively, through actuation of the actuators 804 and 806. Such adjusting may be carried out prior to, during, or after harvesting a row or a field of sugarcane.

Two or more rows of sugarcane may be divided using the pair of row dividers 106, 206 of the removable sugarcane harvester attachment 102. As discussed, the removable sugarcane harvester attachment 102 is configured to removably couple to the machine 104 that carries the removable sugarcane harvester attachment 102. Dividing the rows of sugarcane ensures a smooth cutting operation as sugarcane from other rows does not interfere with the operation of the removable sugarcane harvester attachment 102.

After dividing, bending and knocking down the sugarcane between the pair of row dividers 106, 206 using the knock-down roller 202 may be carried out. Such knocking-down does not uproot the sugarcane. Instead, the knocking-down refers to bowing or orienting the sugarcane in a manner such that the butt of the sugarcane is available for smooth harvesting by the pair of counter-rotating base cutters 208, 210. The knocked-down sugarcane is then pulled in and cut using the pair of counter-rotating base cutters 208, 210 behind the knock-down roller 202. In one embodiment, cutting is carried out, e.g., at a height of 50-70 mm above the ground 122. Subsequently, the cut sugarcane is pushed to the region 188 underneath the machine 104.

The removable sugarcane harvester attachment 102 may be removed by removing the hinge pins 110, 902, 906, and 808. Such removal may be carried out after the sugarcane harvesting operation is complete. After removal, the removable sugarcane harvester attachment 102 may be sent for maintenance or cleaning. Likewise, the machine 104 may be used for other purposes when the removable sugarcane harvester attachment 102 has been removed.

It will be appreciated that the foregoing description provides examples of the disclosed system and technique. However, it is contemplated that other implementations of the disclosure may differ in detail from the foregoing examples. For example, the removable sugarcane harvester attachment 102 may be utilized in cutting other crops similar to sugarcane. Further, the various features of the removable sugarcane harvester attachment 102 are not limited for sugarcane harvesting only, and may additionally be used for other farming purposes where rows of crops need to be harvested. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value fatting within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A removable sugarcane harvester attachment comprising:
a coupler configured to couple the removable sugarcane harvester attachment to a machine;
at least one pair of counter-rotating row dividers; and
at least one pair of counter-rotating base cutters located intermediate of the coupler and the at least one pair of counter-rotating row dividers.

2. The removable sugarcane harvester attachment of claim wherein the coupler includes a first pair of couplers configured to couple the removable sugarcane harvester attachment to a lift arm of the machine via a first pair of hinge pins, the removable sugarcane harvester attachment further comprising:
a knock-down roller positioned between the at least one pair of counter-rotating row dividers and the at least one pair of counter-rotating base cutters, the knock-down roller configured to bend sugarcane pulled in between the at least one pair of counter-rotating row dividers and to push the bent sugarcane towards the at least one pair of counter-rotating base cutters; and
a butt lift roller positioned between the machine and the at least one pair of counter-rotating base cutters and configured to receive cut sugarcane from the at least one pair of counter-rotating base cutters and to push the cut sugarcane towards a region underneath the machine.

3. The removable sugarcane harvester attachment of claim 2, wherein the at least one pair of counter-rotating base cutters are coupled to respective rotating shafts that are further coupled to a body of the removable sugarcane harvester attachment via a beam.

4. The removable sugarcane harvester attachment of claim 2, wherein the butt lift roller comprises a plurality of spokes conjoined at two ends of the butt lift roller, the spokes configured to pull in the cut sugarcane from a spring loaded cylinder member and push out the cut sugarcane to the region underneath the machine.

5. The removable sugarcane harvester attachment of claim 2, wherein the coupler further includes a second pair of couplers coupled to a second pair of hinge pins positioned above the first pair of hinge pins, the second pair of hinge pins further coupled to corresponding actuators on the machine, the actuators configured to move the removable sugarcane harvester attachment based upon a slope of terrain on which the removable sugarcane harvester attachment is used.

6. The removable sugarcane harvester attachment of claim 5, wherein the second pair of couplers are positioned between the machine and the at least one pair of counter-rotating base cutters and above the butt lift roller.

7. The removable sugarcane harvester attachment of claim 5, wherein at least one of the first pair of couplers and the second pair of couplers includes bores.

8. The removable sugarcane harvester attachment of claim 1, wherein the at least one pair of counter-rotating base cutters includes one or more removable blades, the removable sugarcane harvester attachment further comprising:
a pair of guide wheels aligned with a tip of the one or more removable blades, said guide wheels configured to move the removable sugarcane harvester attachment based upon terrain on which the machine moves to harvest sugarcane.

9. The removable sugarcane harvester attachment of claim 1, wherein the at least one pair of counter-rotating row dividers are in a mutually non-parallel orientation.

10. The removable sugarcane harvester attachment of claim 1, wherein the coupler includes a hole to receive a hinge pin that couples the removable sugarcane harvester attachment to the machine.

11. A method of making a removable sugarcane harvester attachment, the method comprising:
providing a coupler configured to couple the removable sugarcane harvester attachment to a machine;
providing a pair of row dividers configured to divide two or more rows of sugarcane, the pair of row dividers being part of the removable sugarcane harvester attachment configured to removably couple to a machine; and
providing a pair of counter-rotating base-cutters located intermediate of the coupler and the pair of counter-rotating row dividers.

12. The method of claim 11 further comprising:
providing a hinge-pin actuatable by an actuator on the machine, the hinge pin arranged to couple with the coupler to adjust an orientation of the removable sugarcane harvester attachment relative to a slope of terrain on which sugarcane is harvested.

13. The method of claim 12, wherein the removable sugarcane harvester attachment is adjustable by a rotation thereof at the hinge pin.

14. The method of claim 12 further comprising:
providing an imaging device on the machine to capture an image of the removable sugarcane harvester attachment.

15. The method of claim 11, wherein the removable sugarcane harvester attachment is configured for operation on sloped terrain.

16. The method of claim 11 further comprising:
providing a knock-down roller positioned between the pair of row dividers and the pair of counter-rotating base cutters, the knock-down roller configured to bend and knock-down sugarcane pulled in between the pair of row dividers, wherein the knocked-down sugarcane is cut at a height of 50-70 mm above a surface where the sugarcane grows.

17. A sugarcane harvester, comprising:
a machine; and
a removable sugarcane harvester attachment coupled to the machine, the removable sugarcane harvester attachment including:
a coupler configured to couple the removable sugarcane harvester attachment to the machine;
at least one pair of counter-rotating row dividers; and
at least one pair of counter-rotating base cutters located intermediate of the coupler and the at least one pair of counter-rotating row dividers.

18. The sugarcane harvester of claim 17, wherein the machine is one of:
a tractor, a skid steer loader (SSL), a multi-terrain loader (MTL), a compact track loader (CTL), or a compact wheel loader (CWL).

19. The sugarcane harvester of claim 17, wherein the removable sugarcane harvester attachment is removably coupled to the machine by a hinge pin removably coupled to the coupler.

20. The sugarcane harvester attachment of claim 17, wherein the sugarcane harvester is configured to adjust a height and/or of the removable sugarcane harvester attachment based upon a terrain upon which the machine moves to harvest sugarcane.
